(19) United States
(12) Patent Application Publication
(10) Pub. No.: US 2005/0003275 A1
(43) Pub. Date: Jan. 6, 2005

(54) Ionic conductor and method of producing the same

(75) Inventor: Hiroshi Nagasawa, Tokyo (JP)

Correspondence Address: BROWDY AND NEIMARK, P.L.L.C.;624 NINTH STREET, NW, SUITE 300, WASHINGTON, DC, 20001-5303, US

(73) Assignee: EBARA CORPORATION, Tokyo (JP)

(21) Appl. No.: 10/768,182

(22) Filed: Feb. 2, 2004

(30) Foreign Application Priority Data
Jan. 31, 2003 (JP) 2003-25123

(51) Int. Cl. H01M 10/36; C25B 13/00

(52) U.S. Cl. 429/304; 204/295

(57) ABSTRACT

The present invention relates to an ionic conductor and a method of producing the ionic conductor, and more particularly to an ionic conductor for use in an ionics element such as a diaphragm and an ionics instrument such as an electrolysis apparatus, and a method of producing such an ionic conductor. The ionic conductor according to the present invention includes a porous body 1 which has a plurality of continuous pores 1a passing through the porous body 1, and ionizable functional groups 2 attached to surfaces of the continuous pores 1a. The porous body 1 comprises a porous ceramics such as a porous glass, a porous alumina, or a porous mullite.

### BACKGROUND OF THE INVENTION

1. Field of the Invention

The present invention relates to an ionic conductor and a method of producing the ionic conductor, and more particularly to an ionic conductor for use in an ionics element and an ionics instrument such as an electrolysis apparatus and a method of producing such an ionic conductor. The present invention also relates to an ionics element and an Tonics instrument using such an ionic conductor.

2. Description of the Related Art

When an electric field is produced in a substance, an electric charge moves through the substance due to the electric field to allow electricity to flow. This phenomenon is generally known as electric conduction, which is classified into electronic conduction and ionic conduction depending on the type of carrier for carrying the electric charge. For example, the electric conduction that is found in metal and semiconductor is the electronic conduction in which an electron serves as a carrier for carrying the electric charge. Electronics elements based on the electronic conduction have been developed as a basic technology of various devises such as a transistor and a diode.

On the other hand, the electric conduction that is found in an electrolyte or the like is the ionic conduction in which various kinds of ions serve as a carrier for carrying the electric charge. For example, a diaphragm has been known as an ionics element utilizing the ionic conduction. Such an ionics element has been used in an electrolysis apparatus for producing various kinds of chemical materials, an electrical measuring device, and an electromotive system, which have been put into practical use as ionics instruments. However, under ordinary temperature conditions, the ionic conduction generally occurs only when the electrolyte is in a liquid state. Therefore, the ionics element and the ionics instrument based on the ionic conduction are difficult to be produced in the form of a device as a solid. This is because the solid should be placed under a high temperature in order for ions to move freely in the solid.

In recent years, there has been developed a solid ionic conductor which allows ions to move therethrough to thereby exhibit an ionic conductivity. Such a solid ionic conductor is divided into two types. One is used only under a high temperature. Examples of this type include a silver iodide crystal and certain types of ceramics. The other is used under a temperature ranging from an ordinary temperature to about 10° C. Examples of this type include an ion exchange resin.

The electrolysis apparatus, which is one of the ionics instruments, has been devised in order to avoid mixing of a raw material and a reaction product with each other during reaction. For example, a soda production using a conventional mercury process employs a method in which a mercury layer is provided so as to convert an ion into a metal compound, instead of moving the ion directly. Specifically, sodium and chlorine obtained by electrolysis are separated so as not to form sodium chlorine, for thereby obtaining the chlorine. However, this mercury process is problematic in environmental pollution and product contamination due to mercury. Therefore, a diaphragm process utilizing various types of diaphragms has been used instead of the mercury process. Initially, an inorganic fiber such as asbestos, which had been formed into a plate-like shape, was used as a diaphragm so that an aqueous solution filled in voids inside the diaphragm allowed ions to move. However, although this diaphragm process is useful in a case where a reaction product produced at one of electrodes is a gas and can be easily separated from other materials, the diaphragm process lacks in capability of preventing mixture of the materials and reverse reaction, and hence productivity is greatly retarded. Then, an ion exchange membrane has been developed, and nowadays the ion exchange membrane has become a mainstream diaphragm which can be used under the ordinary temperature.

A solid polymer membrane (organic polymer) such as ion exchange resin comprises a fluorine-resin-based ion exchange resin membrane having a sulfonic acid group (—SO₃H), and has a structure which allows an ion to pass through a gap between polymer molecules. In the ion exchange resin, a proton hydrate (H₃O⁺) serves as a medium for carrying a proton (H⁺), so that the proton (H⁺) passes through the ion exchange resin made of a solid polymer (organic polymer) and thus carries the electric charge.

However, in the conventional solid polymer (organic polymer) which can be used under the ordinary temperature, since the proton (H⁺) moves through the gap between the polymer molecules, a proton (ion) conductivity is generally low. Specifically, even in a case of a solid polymer which is practically used at present, a proton (ion) conductivity is as low as 2×10⁻³ S/cm. Further, this solid polymer (organic polymer) is deteriorated with time and thus the ionic conductivity is reduced to 5×10⁻⁶ S/cm, thus increasing a reactive resistance. Furthermore, the solid polymer (organic polymer) has a low mechanical strength and is thus difficult to be applied to an independent device. Additionally, in the conventional solid polymer (organic polymer), since the gap between the polymer molecules is small, it is difficult to allow a univalent ion or a multivalent ion, which is larger than a proton (H⁺), to move through the gap, resulting in difficulty in improving the ionic conductivity.

### SUMMARY OF THE INVENTION

The present invention has been made in view of the above drawback. It is therefore an object of the present invention to provide an ionic conductor which can be used under an ordinary temperature and can allow a univalent ion or a multivalent ion, which is larger than a proton (H⁺), to move therethrough for thereby improving an ionic conductivity, and a method of producing such an ionic conductor.

In order to achieve the above object, according to one aspect of the present invention, there is provided an ionic conductor comprising: a porous body which has a plurality of continuous pores passing through the porous body; and ionizable functional groups attached to surfaces of the continuous pores.

As described above, heretofore, the ionic conduction under the ordinary temperature has been performed in such a manner that an ion moves through a liquid-phase substance such as an aqueous solution or an ion moves through the above-mentioned solid polymer. Further, in a case of a solid electrolyte using ceramic or the like, this solid electrolyte is heated to a high temperature to a certain degree so as to allow an ion to move therethrough.

In contrast thereto, the inventor of the present application has found from an extensive study that when various types of ions are transferred by ionizable functional groups which are fixed to a surface of a solid, such ions can move at a relatively high speed against a low resistance. This phenomenon is different from the conventional ion movement in a liquid-phase substance in that mediums for carrying Ions are fixed in position. Such an ionic conduction in which the ionizable functional groups as mediums are fixed to the surface of the solid is the same as the solid polymer electrolyte in that mediums are fixed in position. However, the above ionic conduction is different from this solid polymer electrolyte in that the ion moves freely on the surface or interface or the solid, whereas the solid polymer electrolyte allows the ion to move through the gap between molecules inside the solid. Specifically, since the ion moves on the surface or interface of the solid, the ion can move freely without being restricted by a magnitude of the gap.

However, when such a surface propagation phenomena of the ion is utilized to produce an ionic conductor and is applied to various types of ionics elements, the following problem arise: Since the propagation of the ion is performed by utilizing only the surface of the solid, an absolute amount of the ions for movement is insufficient and thus the application to a diaphragm or the like is difficult. The present inventor has succeeded in producing a practically usable ionic conductor by combining the surface propagation phenomena of the ion with a porous body having a large surface area. Particularly, the present inventor has conducted a study of a ceramic-based porous material so as to use as the porous body and utilize surfaces of a number of pores formed therein, and then found an ionic conductor having a large ionic conductivity and a solid appearance.

Therefore, according to the ionic conductor of the present invention, by attaching the ionizable functional groups to the surfaces of a plurality of the continuous pores (hereinafter referred to as pores) passing through the porous body, various kinds of ions are attracted to the surfaces of the pores and are transferred on the surfaces, thus allowing the ions to move through the inside of the porous body. Further, this structure allows the various kinds of ions such as a univalent ion or a multivalent ion to move freely, and hence the ionic conductivity can be greatly improved.

In a preferred aspect of the present invention, the porous body comprises a porous ceramics.

The ionic conductor according to the present invention may comprise an organic porous body. However, in consideration of a mechanical strength and a chemical stability, it is preferable to use the porous ceramics as the porous body.

In a preferred aspect of the present invention, the porous ceramics comprises a porous glass, a porous alumina, or a porous mullite.

In a preferred aspect of the present invention, an average diameter of the continuous pores is in the range of 1 nm to 1 μm, and a porosity of the porous body is in the range of 5 to 90%.

According to the present invention, it is possible to prevent a liquid from passing through the ionic conductor and simultaneously allow various types of ions to move through the ionic conductor. It is Preferable that the diameter of the continuous pore is determined depending on the type or ion which is an object for movement.

In a preferred aspect of the present invention, hydrophobic groups are attached to the surfaces of the continuous pores.

In a preferred aspect of the present invention, the hydrophobic groups are alkyl groups or fluorocarbon functional groups.

According to the present invention, the surfaces of the pores can exhibit water repellency. Therefore, it is possible to prevent a liquid from passing through the pores more effectively. The alkyl group and the fluorocarbon functional group are preferably used as the hydrophobic group (the functional group having a property of water repellency). It is not essential to attach the hydrophobic groups to the pores because the entrance of the liquid into the pores can be prevented by action of surface tension. However, in a case where the hydrophobic groups and the ionizable functional groups are present on the surfaces of the pores in a mixed state, it is possible to greatly improve a selectivity of the ion for movement and a durability of the ionic conductor,

In a preferred aspect of the present invention, the porous body has a plate-like shape, a pipe-like shape, or a honeycomb shape.

The ionic conductor according to the present invention can employ the various porous bodies having a variety of shapes depending on usage of the ionic conductor.

According to another aspect of the present invention, there is provide a method of producing an ionic conductor, the method comprising: preparing a porous body which has a plurality of continuous pores passing through the porous body; and attaching ionizable functional groups to active groups being present on surfaces of the continuous pores by a covalent bond or a hydrogen bond.

According to another aspect of the present invention, there is provide a method of producing an ionic conductor, the method comprising: preparing a porous body which has a plurality of continuous pores passing through the porous body; bonding hydrophobic groups to active groups being present on surfaces of the continuous pores: and attaching one of anionic surface active agents, cationic surface active agents, and amphoteric surface active agents, each of which has ionizable functional groups and one of alkyl groups and fluorocarbon functional groups, to the hydrophobic groups.

According to another aspect of the present invention, there is provide an ionic conductive diaphragm comprising an ionic conductor, characterized in that: the ionic conductor comprises a porous body which has a plurality of continuous pores passing through the porous body, and ionizable functional groups attached to surfaces of the continuous pores.

According to another aspect of the present invention, there is provide an ionics element comprising an ionic conductor, characterized in that: the ionic conductor comprises a porous body which has a plurality of continuous pores passing through the porous body, and ionizable functional groups attached to surfaces of the continuous pores.

According to another aspect of the present invention, there is provide an ionics instrument having an ionic conductor, characterized in that: the ionic conductor comprises a porous body which has a plurality of continuous pores passing through the porous body, and ionizable functional groups attached to surfaces of the continuous pores.

It can be considered that the ionics element is a component for constituting the ionics instrument. Examples of the ionics elements include a diaphragm. The ionics instrument is a type of instrument having such ionics element, and also implies a concept including an ion measuring device, an electrolysis apparatus, and an electromotive apparatus, each of which is a type of instrument utilizing the ionics conduction.

### BRIEF DESCRIPTION OF THE DRAWINGS

FIG. 1A is a schematic cross-sectional view showing a part of an ionic conductor according to a first embodiment of the present invention;

FIG. 1B is an enlarged cross-sectional view showing a pore in FIG. 1A;

FIG. 1C is an enlarged cross-sectional view schematically showing a surface of the pore in FIG. 1B;

FIG. 2 is an enlarged cross-sectional view schematically showing a pore formed in an ionic conductor according to a second embodiment of the present invention;

FIG. 3A is a schematic view showing a surface of a pore formed in an ionic conductor according to a third embodiment of the present invention;

FIG. 3B is a schematic view showing a state in which silanol groups are exposed on the surface of the pore with no ionizable functional group attached thereto;

FIG. 4 is a graph showing a relationship between a perchloric acid ion activity and an electric potential difference in the case of the ionic conductor according to the third embodiment (indicated by a curved line A) and in the case of a porous glass with no ionizable functional group (indicated by a curved line B);

FIG. 5 is a scanning electron micrograph showing a porous glass having pores whose average diameter is 200 nm; and

FIG. 6 is a graph showing a pore diameter distribution of porous glasses having pores formed therein whose average diameters are 6 nm (graph A), 10 nm (graph B), 30 nm (graph C), 50 nm (graph D), and 100 nm (graph E), respectively.

### DETAILED DESCRIPTION OF THE PREFERRED EMBODIMENTS

Hereinafter, embodiments of the present invention will be described with reference to the drawings.

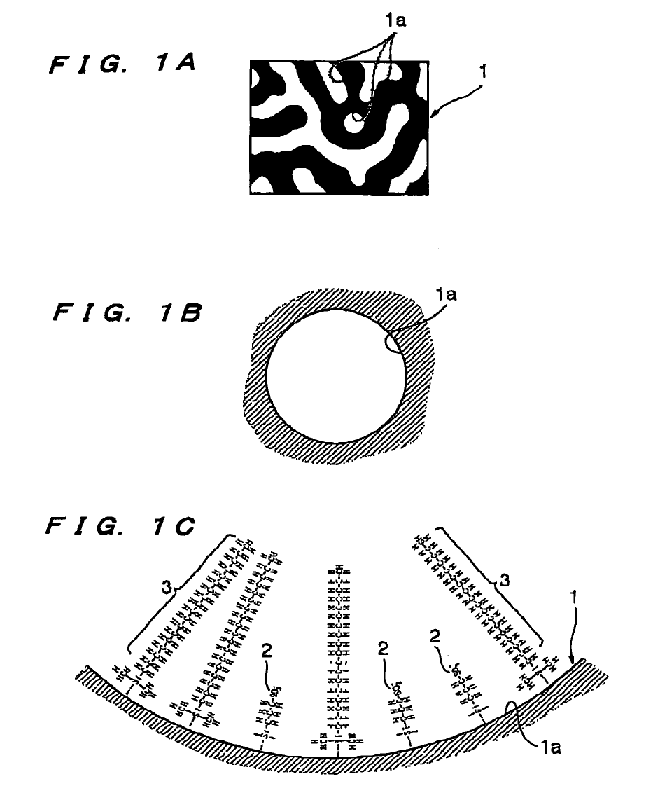

FIG. 1A is a schematic cross-sectional view showing a part of an ionic conductor according to a first embodiment of the present invention, FIG. 1B is an enlarged cross-sectional view showing a pore in FIG. 1A, and FIG. 1C is an enlarged cross-sectional view schematically showing a surface of the pore in FIG. 1B.

As shown in FIG. 1A, a porous body 1 comprises a porous glass which has a number of continuous pores la (hereinafter referred to as poses) formed therein and passing therethrough. Specifically, this porous glass (porous body) 1 comprises a high-silicic acid type porous glass made of SiO₂ or a multi-component glass (e.g., SiO₂—P₂O₅, SiO₂—Al₂O₃, SiO₂—GeO₂, SiO₂—ZrO₂). Instead of the porous glass, other porous ceramics such as a porous mullite (aluminosilicate) or a porous alumina may be used as long as such a porous ceramics has a rigidity to a certain degree and an ionizable functional group and a hydrophobic group can be easily attached thereto.

As shown in FIG. 1C, ionizable functional groups (—SO₃⁻) 2 derived from sulfonic acid groups (—SO₃H) are attached to surfaces of the pores la formed inside the porous glass 1. Further, although not shown in the drawings, the ionizable functional groups derived from the sulfonic acid groups are also attached to a surface of the porous glass 1, other than the surfaces of the pores 1a. In this manner, the ionizable functional groups 2 are attached to the entire surface, which includes the surfaces of the pores 1a, of the porous glass 1, and hence an ionic conductivity can be imparted to the porous glass (porous body) 1. The ionizable functional groups to be attached to the porous glass 1 have a capability of discriminating a specific ion so that the discriminated ion is selectively permeable to, distributed by, or attached to the porous glass 1. With this structure, a sufficient ionic conductivity can be obtained due to the ion permeation, compared with a salt bridge or an impregnant filled with an electrolyte solution as a medium for selectively allowing an ion to pass therethrough.

As shown in FIG. 1C, alkyl groups (—CₙH₂₊ₐ) 3 as hydrophobic groups are attached to the surface, which includes the surfaces of the pores 1, of the porous glass 1. In this manner, the porous glass (porous body) 1 has the alkyl groups 3 attached thereto and thus exhibits water repellency. Therefore, water as a solvent of an aqueous solution serving as an ion supply source is repelled by the alkyl groups 3 as the hydrophobic groups, thus preventing the water (liquid) from entering the inside of the ionic conductor. Therefore, the alkyl groups attached to the surface, which includes the surfaces of the pores 1, of the porous glass 1 can prevent the liquid from passing through the porous glass 1, and simultaneously, the ionizable functional groups 2 attached to the surfaces of the pores la can allow the various types of ions such as a univalent ion or a multivalent ion to move.

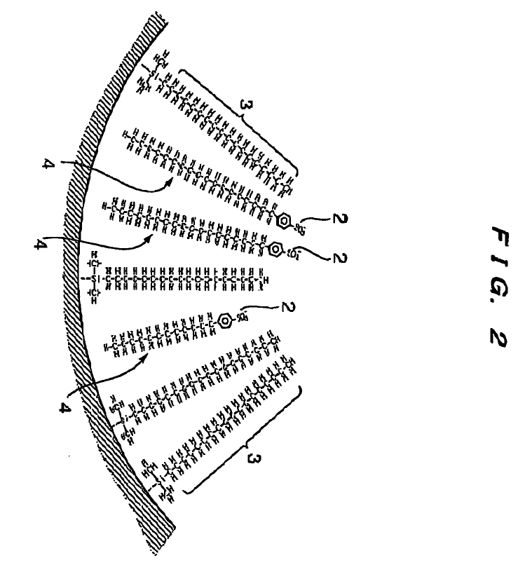

Next, a second embodiment according to the present invention will be described with reference to FIG. 2.

FIG. 2 is an enlarged cross-sectional view schematically showing a pore formed in an ionic conductor according to the present embodiment. The porous body used in this embodiment is a porous glass, as with the first embodiment described above. However, instead of the porous glass, other porous ceramics such as a porous mullite or a porous alumina may be used.

As shown in FIG. 2, alkyl groups (octadecyl groups, —C₁₈H₃₇) 3 as hydrophobic groups are bonded to the surfaces of the pores formed in the porous glass. Further, anionic surface active agents (alkylbenzene sulfonic acids) 4, which have ionizable functional groups (—SO₃⁻) 2 derived from sulfonic acid groups and alkyl groups as hydrophobic groups, are attached onto the alkyl groups 3. Attachment of the anionic surface active agents 4 to the alkyl groups (octadecyl groups) 3 is performed by a so-called dynamic coating process which utilizes a hydrophobic bond. According to the dynamic coating process, the alkyl groups (octadecyl groups) 3 having a hydrophobicity and hydrophobic parts of the anionic surface active agents 4 are attracted to each other, so that the ionizable functional groups (—SO₃⁻) 2 of the anionic surface active agents 4 are attached to the surfaces of the pores 1a. In this manner, the ionic conductor according to this embodiment can prevent the liquid from passing therethrough and can obtain an excellent ionic conductivity, as with the first embodiment.

Instead of the anionic surface active agent, cationic surface active agent or amphoteric surface active agent may be used. For example, alkyl quaternary ammonium salt may preferably be used as the cationic surface active agent, and chloroalkyl sulfonic acid sodium or aminosulfonic acid sodium may preferably be used as the amphoteric surface active agent. Fluorocarbon functional group (—CₙF₂ₙ₊₁) may be used as the hydrophobic group to be bonded to the surface of the pore instead of the alkyl group. Further, anionic surface active agent, cationic surface active agent, or amphoteric surface active agent each having a fluorocarbon functional group may be used as the surface active agent.

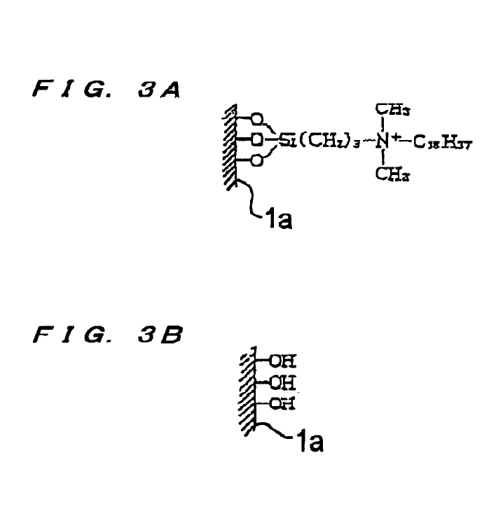

Next, a third embodiment of the present invention will be described with reference to FIG. 3.

FIG. 3A is a schematic view showing a surface of a pore formed in an ionic conductor according to the present embodiment, and FIG. 3B is a schematic view showing a state in which silanol groups (—SiOH) are exposed on the surface of the pore with no ionizable functional group attached thereto, and also showing a comparative example of the present invention. The porous body used in this embodiment is a porous glass, as with the first embodiment described above. However, instead of the porous glass, other porous ceramics such as a porous mullite or a porous alumina may be used.

As shown in FIG. 3A, propane sultone (C₂H₆SO₃) having an alkyl group (—CₙH₂ₙ₊₁) as a hydrophobic group is attached to the surface of the pore 1a, and an ionizable functional group (—N⁺(CH₃)₃) derived from quaternary ammonium is bonded to the propane sultone. This ionizable functional group can be bonded to the propane sultone by introducing the alkyl quaternary ammonium salt serving as the cationic surface active agent into the porous glass.

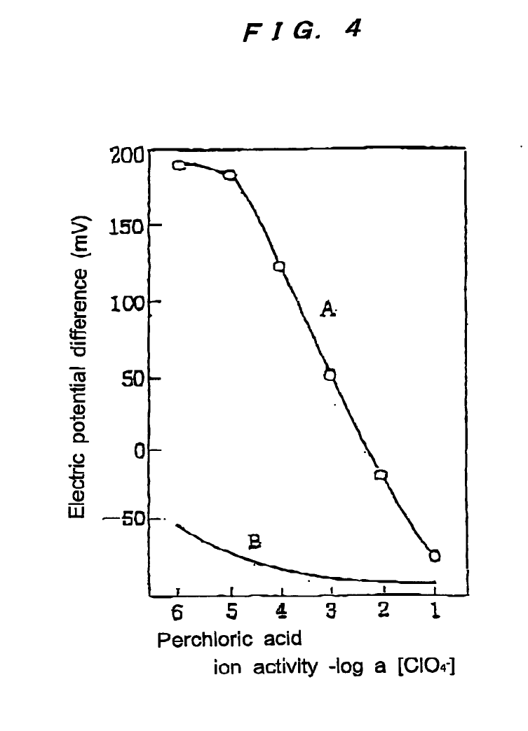

Hereinafter, the ionic conductivity of the ionic conductor according to the third embodiment of the present invention shown in FIG. 3A will be described with reference to FIG. 4. FIG. 4 is a graph showing a relationship between a perchloric acid ion activity and an electric potential difference in the case of the ionic conductor according to the third embodiment (indicated by a curved line A) and in the case of a porous glass with no ionizable functional group (indicated by a curved line B).

As shown in FIG. 4, an electric potential difference indicated by the curved line A is greatly higher than that indicated by the curved line B with the same perchloric acid ion activities. Specifically, FIG. 4 shows that the ionizable functional group fixed to the surface of the porous glass has a high capability of carrying an electric charge. Therefore, it is possible to greatly improve the ionic conductivity by selecting a suitable ionizable functional group from among an anion group such as a sulfate group (sulfonic acid group), a cation group such as a quaternary ammonium group, and an amphoteric group, and then attaching the selected ionizable functional group to the surface of the porous glass (porous body).

Specifically, in a case where a proton (H⁺) serves as an electric charge to move, an ionizable functional group (e.g., a sulfonic acid group as a cation-exchange group) which discriminates a hydrogen ion to pass it through the pore with a high sensitivity is attached to the surface of the pore of the porous glass to constitute the ionic conductor. This ionic conductor can secure a sufficient and suitable ionic conductivity.

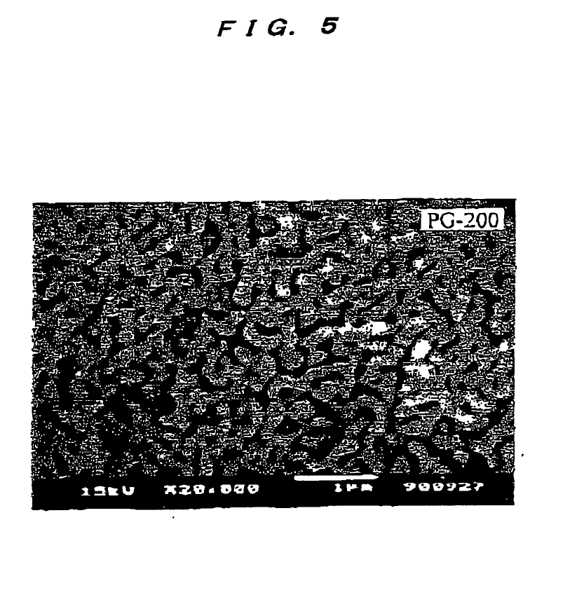

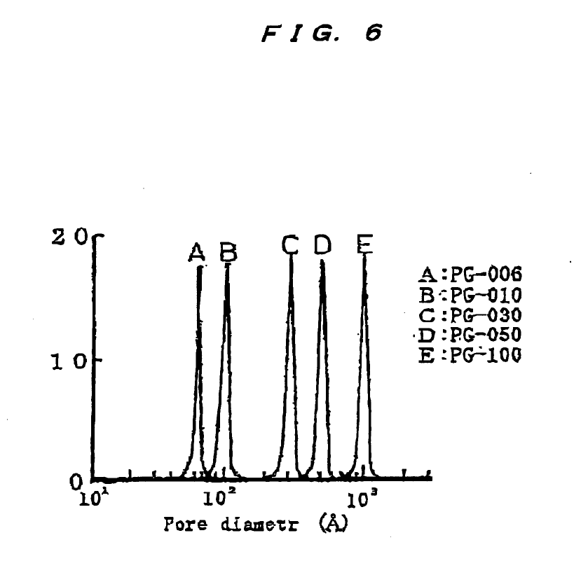

FIG. 5 is a scanning electron micrograph showing a porous glass having pores whose average diameter is 200 nm. FIG. 6 is a graph showing a pore diameter distribution of porous glasses having pores formed therein whose average diameters are 6 nm (graph A), 10 nm (graph B), 30 nm (graph C), 50 nm (graph D), and 100 nm (graph E), respectively.

As shown in FIG. 6, the porous glass has the pores whose diameters are substantially uniform and are not scattered, and these pores are uniformly distributed in the porous glass. With this porous glass, the diameters of the pores can be easily controlled as long as the minimum diameter is 100 Å, for example. By controlling the diameters of the pores, it is possible to avoid permeation of water having no ionicity and other solvent molecule. Therefore, since the porous glass whose pore diameter can be easily controlled is used as the porous body, a practically suitable diameter of the pore can be obtained such that a solvent liquid is prevented from leaking through the ionic conductor (the porous glass) and the ionic conductivity is maximized.

Experiment was carried out using the ionic conductor according to the present invention in the form of a diaphragm (hereinafter, referred to as an ionic conductive diaphragm). In this experiment, the ionic conductive diaphragms having a variety of thicknesses thereof and pore diameters (4 to 500 nm) were used. The experiment result confirmed that an amount of the carried electric charges was maximized by approximately selecting the thickness and the pore diameter. For example, in a case of using the porous glass as the porous body for constituting the ionic conductive diaphragm, the thickness is preferably in the range of 1 μm to 1 mm, and more preferably in the range of 150 μm to 500 μm. This reason is as follows: If the thickness is less than 1 μm, it becomes difficult to form the porous glass (the ionic conductive diaphragm) having a uniform thickness. On the other hand, if the thickness is more than 1 mm, a resistance against the movement of the ion becomes large. In a case where the ionic conductor according to the present invention is used as the diaphragm, it is effective to use a support member in order to secure in mechanical strength so that the ionic conductor is constituted as a non-uniform membrane.

The pore diameter is determined in consideration of the ionic conductivity, avoidance of leakage of the solvent liquid, and the like. Generally, for a proton (He) to move, the pore diameter is set in the range of 1 nm to 1 μm, preferably in the range of 1 nm to 100 nm, and more preferably in the range of 4 nm to 50 nm If the pore diameter is excessively small, the movement of the ion is retarded, and if the pore diameter is excessively large, the leakage prevention of the solvent liquid is insufficient. A porosity of the porous body is generally set in the range of 5 to 90%, preferably in the range of 10 to 70%, and more preferably in the range of 20 to 60% The porous glass having a porosity of 50 to 60% is generally used. As a porosity of the porous body becomes large, the resistance against the movement of the ion becomes small and the ion can thus move efficiently. However, the strength of the porous body is lowered. With consideration of the leakage prevention of the solvent liquid, the entire ionic conductor is not necessarily dense. In this case, only a portion such as an end surface may be dense, as long as there is no problem in terms of manufacturing.

The hydrophobic functional group attached to the surface of the pore can prevent a hydrophilic substance from passing through the pore, thereby avoiding a leakage of water serving as a solvent through the ionic conductive diaphragm (the porous glass membrane). Further, a practically suitable diameter of the pore can be obtained such that a conductivity of an ion (e.g., a proton) is maximized.

For example, if an alkyl group as the hydrophobic group is attached to the surface of the pore, a hydrophobicity of the inside of the pore is increased, thus enabling prevention of a leakage of a solvent liquid. With consideration of the leakage prevention of the solvent liquid, it is not necessary to attach the alkyl group to the entire ionic conductor. In this case, the alkyl group may be attached only to a portion such as an end surface, as long as there is no problem in terms of manufacturing.

Next, a method of producing the ionic conductor having a film-like porous glass as a porous body according to the present invention will be described. The porous body of the present invention is not limited to the porous glass as long as a functional group can be attached to the surface of the porous body, and other porous ceramics such as a porous mullite or a porous alumina may be used instead of the porous glass.

Examples of processes of producing the porous glass for use in the ionic conductor include a phase splitting process, a sol-gel process, and a sintering process for uniform powder. Hereinafter, there will be described an example of producing a porous glass using the phase splitting process.

First, a glass material comprising Na₂O—B₂O₃—SiO₂, for example, is molded to a predetermined shape. Then, a hear treatment (500 to 600° C.) of the glass material having the predetermined shape is performed so as to split the glass material into a Na₂O—B₂O₃ phase and a SiO₂ phase. Thereafter, an acid treatment of the glass material is performed so as to elute and remove the Na₂O—B₂O₃ phase, so that a porous glass comprising a bone structure of the SiO₂ phase is obtained. The present inventor has reported that diameters of pores can be controlled by a composition of the glass material, a heat treatment condition (e.g., temperature and time) of the phase splitting process, and a condition of elution due to acid (H. Tanaka, H. Nagasawa et, all: journal of Non-crystalline solids 65 p 301-309, (1984)).

Next, there will be described a process of attaching functional groups to the entire surface, which includes the surfaces of the pores, or the porous glass which has been produced in the manner as described above. A dynamic coating process and a direct process will be taken for examples in the following description. The dynamic coating process which will be described below is a process for producing an ionic conductor according to the second embodiment shown in FIG. 2.

\mathring{1} Dynamic Coating Process

The porous glass which has been produced in the manner as described above is dipped into toluene (C₇H₈) in which octadecyltrichlorosilane (C₁₈H₃₇C₃Si, ODS) has been dispersed, and is heated under reflux in a flask, for example, having a cooler. At this time, it is preferable to agitate the toluene by blowing an N₂ gas, rather than by a mechanical agitation. An amount of the octadecyltrichlorosilane to be attached can be adjusted by a reaction temperature and a reaction time. Generally, the reaction is performed for about two hours at a boiling point (110.6° C.) of the toluene, so that an alkyl groups are bonded to silanol groups (—SiOH) as active groups exposed on the surface of the porous glass, whereby the attachment of the alkyl groups is completed.

After attaching the alkyl groups, the porous glass is dipped into toluene to which sodium alkylbenzene sulfonate (e.g., sodium dodecyl benzene sulfonate, C₁₈H₂₉SONa) has been added for 15 to 60 minutes. Thereafter, the porous glass is extracted from the toluene and then dried at an ordinary temperature. With this process, hydrophobic groups of the sodium alkylbenzene sulfonate are attracted to the alkyl groups as hydrophobic groups, and hence the ionizable functional groups (—SO₃⁻) derived from sulfonic acid groups are present on the surface of the porous glass, thus imparting a conductivity (an ionic conductivity) to the porous glass. The conductivity can be controlled by adjusting an amount of the sodium alkylbenzene sulfonate to be added and a dipping time of the porous glass into the toluene.

\mathring{2} Direct Process (A First Example)

The porous glass which has been produced in the manner as described above is dipped into toluene in which a phenyl-based silane coupling agent such as phenyltrichlorosilane (C₆H₅Cl₃Si) has been dispersed, and is heated under reflux in a flask, for example, having a cooler. An attachment rate of the silane coupling agent can be adjusted by an amount of the silane coupling agent to be added, a reaction temperature, and a reaction time. Generally, the reaction is performed for about two hours at a boiling point of the toluene.

This sample is mixed with concentrated sulfuric acid or the like for sulfonation, and then dried at an ordinary temperature for about a day. A sulfonation rate of the alkyl group varies depending on a sulfonation condition, thus enabling the control of the conductivity (the ionic conductivity).

\mathring{3} Direct Process (A Second Example)

The process which will be described below is a process for producing an ionic conductor according to the first embodiment of the present invention shown in FIG. 1C. First, the porous glass which has been produced in the manner as described above is dipped into toluene in which a propane sultone (C₃H₆SO₃, PS) has been dispersed, and is heated under reflux in a flask, for example, having a cooler. An attachment rate of the propane sultone can be adjusted by an amount of the propane sultone to be added, a reaction temperature, and a reaction time. Generally, the reaction is performed for about two hours at a boiling point of the toluene. The propane sultone is bonded to a silanol group (—SiOH) exposed on the surface of the porous glass according to a ring-opening reaction described below, and hence —C₃H₅SO₃H groups are introduced to the surface of the porous glass.
—SiOH+C₃H₆SO₃→—SiO—C₃H₅SO₃H

This —C₃H₅SO₃H group has a sulfonic acid group and an alkyl group. Therefore, ionizable functional groups derived from the sulfonic acid groups and hydrophobic groups comprising the alkyl groups are attached to the surface, which includes the surfaces of the pores, of the porous glass.

The porous glass having the alkyl groups attached thereto is dipped into toluene in which octadecyltrichlorosilane (C₁₈H₃₇Cl₃Si, ODS) has been dispersed, and is heated under reflux in a flask or the like having a cooler. An amount of the octadecyltrichlorosilane to be attached can be adjusted by a reaction temperature and a reaction time. Generally, the reaction is performed for about two hours at a boiling point of the toluene. The attachment of the additional alkyl groups is thus completed.

In the above-mentioned first and second direct processes, the ionizable functional groups are attached to the surfaces of the pores of the porous glass (porous body) by a covalent bond. The ionizable functional groups may be attached to the surfaces of the pores by a hydrogen bond. In this case, the porous glass (porous body) is dipped into a concentrated sulfuric acid or a dilute sulfuric acid for a predetermined time, so that sulfonic acid groups are attracted to silanol groups exposed on the surface of the porous glass by a hydrogen bond. With this process, the ionizable functional groups derived from the sulfonic acid groups can be attached to the surfaces of the pores.

As described above, according to the present invention, it is possible to allow an ion, which serves as a basis of an ionic conduction, to move on the surfaces of the pores of the porous body to which the ionizable functional groups are attached, instead of allowing the ions to move through the inside of the solid polymer. Further, it is possible to substantially prevent a liquid from entering the inside of the ionic conductor, thereby preventing the ionic conductivity from being lowered with time. As a result, the conductivity can be improved 10 to 100 times that of the conventional solid-polymer-type ionic conductor, and the ionic conductor having an excellent mechanical and thermal strength can be obtained.

1. An ionic conductor comprising:
a porous body which has a plurality of continuous pores passing through said porous body; and
ionizable functional groups attached to surfaces of said continuous pores.

2. An ionic conductor according to claim 1, wherein said porous body comprises a porous ceramics.

3. An ionic conductor according to claim 2, wherein said porous ceramics comprises a porous glass, a porous alumina, or a porous mullite.

4. An ionic conductor according to claim 1, wherein an average diameter of said continuous pores is in the range of 1 nm to 1 μm, and a porosity of said porous body is in the range of 5 to 90%.

5. An ionic conductor according to claim 1, wherein hydrophobic groups are attached to the surfaces of said continuous pores.

6. An ionic conductor according to claim 5, wherein said hydrophobic groups are alkyl groups or fluorocarbon functional groups.

7. An ionic conductor according to claim 1, wherein said porous body has a plate-like shape, a pipe-like shape, or a honeycomb shape.

8. A method of producing an ionic conductor, said method comprising;
preparing a porous body which has a plurality of continuous pores passing through said porous body; and
attaching ionizable functional groups to active groups being present on surfaces of said continuous pores by a covalent bond or a hydrogen bond.

9. A method of producing an ionic conductor, said method comprising:
preparing a porous body which has a plurality of continuous pores passing through said porous body;
bonding hydrophobic groups to active groups being present on surfaces of said continuous pores; and
attaching one of anionic surface active agents, cationic surface active agents, and amphoteric surface active agents, each of which has ionizable functional groups and one or alkyl groups and fluorocarbon functional groups, to said hydrophobic groups.

10. An ionic conductive diaphragm comprising an ionic conductor, characterized in that:
said ionic conductor comprises a porous body which has a plurality of continuous pores passing through said porous body, and ionizable functional groups attached to surfaces of said continuous pores.

11. An ionics element comprising an ionic conductor, characterized in that:
said ionic conductor comprises a porous body which has a plurality of continuous pores passing through said porous body, and ionizable functional groups attached to surfaces of said continuous pores.

12. An ionics instrument having an ionic conductor, characterized in that;
said ionic conductor comprises a porous body which has a plurality of continuous pores passing through said porous body, and ionizable functional groups attached to surfaces of said continuous pores.
